(19) United States
(12) Patent Application Publication
(10) Pub. No.: US 2002/0163209 A1
(43) Pub. Date: Nov. 7, 2002

(54) Inner handle assembly of a sliding door

(76) Inventor: Jae-hong Choi, Namyangju-shi (KR)

Correspondence Address: DAVIS & BUJOLD, P.L.L.C., 500 NORTH COMMERCIAL STREET, FOURTH FLOOR, MANCHESTER, NH, 03101, US

(21) Appl. No.: 09/782,363

(22) Filed: Feb. 13, 2001

(30) Foreign Application Priority Data
Nov. 14, 2000 (KR) 2000-67374

(51) Int. Cl. E05B 3/00

(52) U.S. Cl. 292/336.3

(57) ABSTRACT

Disclosed is an inner handle assembly mounted on a sliding door of a car. An inner handle is fixed at a housing to rotate in both directions and always returned to a neutral position by an inner handle operation controlling mechanism. Therefore, if the inner handle is turned in the door opening direction or if the door closing direction from the neutral position, a door-open maintaining mechanism or a door-close maintaining mechanism is released. Therefore, only by applying power in any one direction of the inner handle, the sliding door can be easily opened or shut.

### BACKGROUND OF THE INVENTION

1. Field of the Invention

The present invention relates to an inner handle assembly mounted to a sliding door, and more particularly, to an inner handle assembly of a sliding door having a door-open maintaining means for maintaining an opened state of the sliding door, which can allow an inner handle to be operated conveniently to open and shut the sliding door.

2. Description of the Related Art

A sliding door mounted on a van type car is in a sliding type that it slides in the back and forth direction of a car body along the side surface of the car body to be opened or shut. Therefore, passengers can get in or off the car easily and the opening and shutting of the door is not interfered from the surroundings even in a small area.

Identically with a general hinged door, the conventional sliding door includes a door-close maintaining means for maintaining a closed state of the door, a locking controller connected to the door-close maintaining means to control the operation of the door-close maintaining means, inner handle assembly and outer handle assembly connected to the locking controller to release the door from the closed state, and a door locking knob connected to the locking controller for controlling the locking controller to lock the door in the closed state. If the door opened is closed, the door is automatically fastened by the door-close maintaining means not to be opened. When inner and outer handles are operated in the state that the door is closed, the door-close maintaining means is released to open the closed door. When the door locking knob is operated, the door is not opened even though the inner and outer handles are operated in the state that the door is closed.

However, in the conventional sliding door, if the door is opened in the state that the car is parked on a slanted road surface, the door is automatically closed by self-weight, thereby the passenger may be injured by the automatically closed door. To prevent the problem, the passengers must hold the opened door.

To solve the problem, a method for installing a door-open maintaining means inside the sliding door to maintain the open state of the door has been disclosed and widely used. Moreover, the locking controller, the inner handle and the outer handle have been under study in many directions to control the operation of the door-open maintaining means.

For an example, a sliding door control assembly is disclosed in U.S. Pat. No. 5,605,363 assigned to Chrysler Corporation. In such sliding door control assembly, if the outer handle is pulled, the door-open maintaining means and the door-close maintaining means are simultaneously released. If the passenger grasps the inner handle and presses a button mounted on the inner handle, the door-open maintaining means and the door-close maintaining means are simultaneously released.

In case of the outer handle, as the passenger, who stands outside, operates the outer handle, the operation of the handle is natural. However, in case of the inner handle, as the passenger must slide the door to open or shut in a small area of the inside of the car while grasping the inner handle with one hand and pressing the button, thereby it is very difficult and complicate in releasing the sliding door.

For another example, a method that the door-open maintaining means and the door-close maintaining means are released simultaneously when the inner handle is pulled in the same way as the outer handle has been also disclosed and used. However, the method is more complicate in releasing the sliding door than the sliding door control assembly disclosed in U.S. Pat. No. 5,605,363.

### SUMMARY OF THE INVENTION

It is, therefore, an object of the present invention to provide an inner handle assembly of a sliding door, which allows an inner handle to be operated conveniently to open and shut the sliding door.

To achieve the above object, the present invention provides an inner handle assembly of a sliding door comprising: a housing having a plurality of coupling parts and/or projections, the housing being assembled inside the sliding door through the medium of a coupling member such as a screw; an inner handle hinged to the housing to rotate in both directions; and an inner handle operation controlling means for controlling the operation of the inner handle to be always returned to a neutral position.

### BRIEF DESCRIPTION OF THE DRAWINGS

Further objects and advantages of the invention can be more fully understood from the following detailed description taken in conjunction with the accompanying drawings in which:

FIG. 1 is a schematic view of a sliding door opening and shutting device having an inner handle assembly according to the present invention; and

FIGS. 2a and 2b are perspective views, seen from different directions from each other, of an example of the inner handle assembly according to the present invention.

### DETAILED DESCRIPTION OF THE PREFERRED EMBODIMENT

The present invention will now be described in detail in connection with preferred embodiments with reference to the accompanying drawings. For reference, like reference characters designate corresponding parts throughout several views.

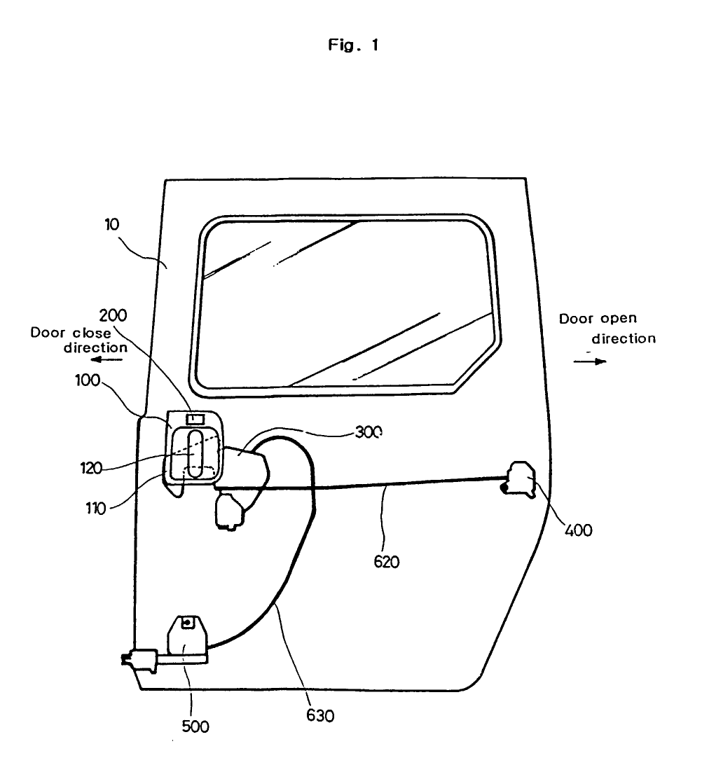

FIG. 1 is a schematic view of a construction of a sliding door opening and shutting device having an inner handle assembly according to the present invention. In FIG. 1, the sliding door opening and shutting device includes a door -close maintaining means 400 for maintaining a closed state of a sliding door 10, a door-open maintaining means 500 for maintaining an opened state of the sliding door 10, a locking controller 300 connected to the door-close maintaining means 400 and the door-open maintaining means 500 to control the operation of the door-close maintaining means 400 and the door-open maintaining means 500, inner handle assembly 100 and outer handle assembly operating the locking controller 300 to selectively release the sliding door 10 from the closed state, and a door locking knob 200 connected to the locking controller 300 to control the operation of the locking controller 300.

The connected operation of the components of the sliding door opening and shutting device will be described briefly. If an inner handle 120 and an outer handle which are respectively provided to the inner handle assembly 100 and the outer handle assembly, are manipulated, the locking controller 300 connected to the handles is operated, and thereby the door-close maintaining means 400 and the door-open maintaining means 500 are selectively released by the locking controller 300. If the door locking knob 200 is operated, the operation of the locking controller 300 connected to the door locking knob 200 is controlled, and thereby the operation of the locking controller 300 by the inner handle 120 and the outer handle is selectively stopped.

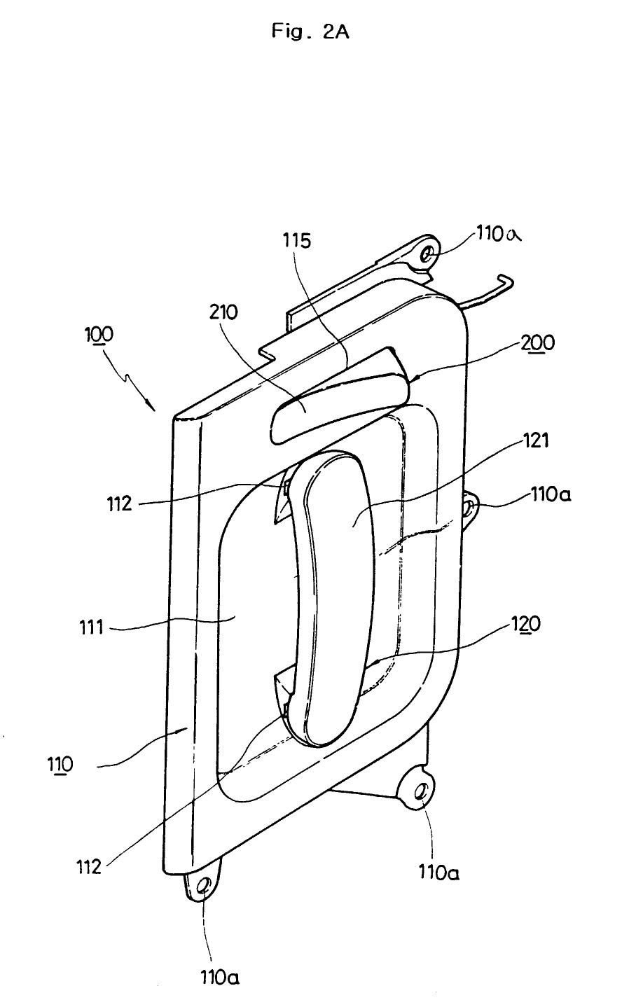

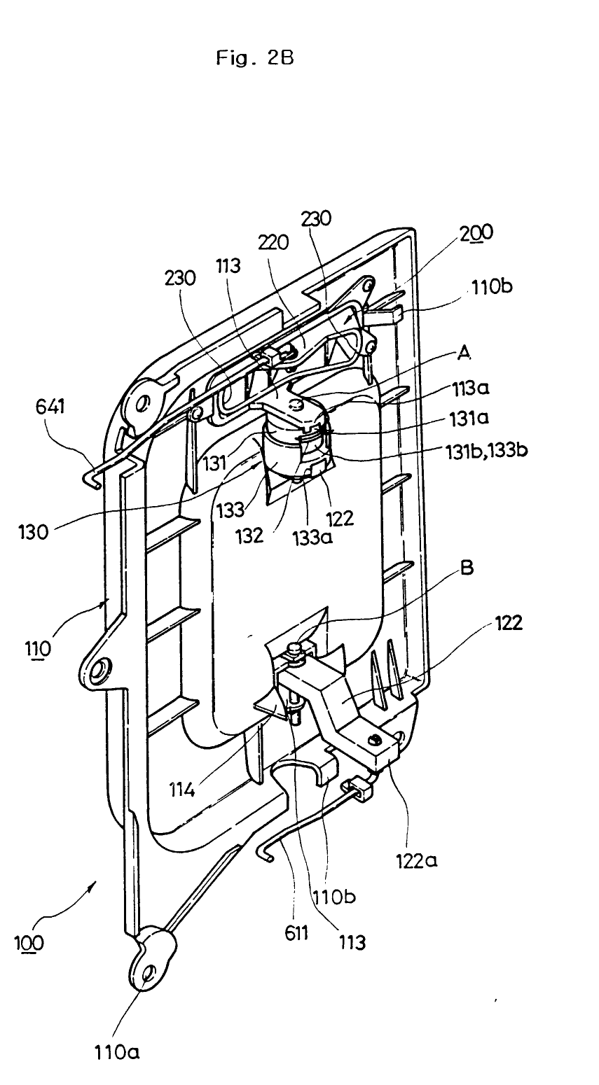

FIGS. 2a and 2b are perspective views, seen from different directions from each other, of the inner handle assembly of FIG. 1. In FIGS. 2a and 2b, the inner handle assembly includes: a housing 110 having a plurality of coupling parts 110a and projections 110b, the housing 110 being assembled inside the sliding door 10 through the medium of a coupling member such as a screw; the inner handle 120 hinged to the housing 110 to rotate in both directions; and an inner handle operation controlling means 130 for controlling the operation of the inner handle 120 to be always returned to a neutral position. The housing 110 includes an inner handle seating space 111 formed in an exposed surface of the housing 110, a pair of insertion holes 112 for inserting both ends of the inner handle 120 through the insertion holes 112, a pair of hinge connecting parts 113 formed oppositely at the upper and lower portions of the rear surface of the housing 110 to fix the ends of the inner handle 120, a stopper 114 formed at both sides of the lower insertion hole 112 to control an angle of rotation of the inner handle 120, and a fixing part 113a of a convexo-concave form formed at the bottom of the hinge connecting part 113 arranged higher than the upper insertion hole 112. The housing further includes a knob insertion hole 115 formed at a portion located higher than the inner handle seating space 111 to insert the door locking knob 200 through the knob insertion hole 115, and thereby the door locking knob 200 is rotatably mounted on a hinge shaft (not shown). The hinge shaft is located at the center of the door locking knob 200 to make the door locking knob 200 rotate in right and left directions on the hinge shaft. The door locking knob 200 includes an operation part 210 formed on an exposed surface of the door locking knob 200, a rod connecting part 220 formed at the rear surface to connect a rod 641, and a stopper 230 for controlling an angle of rotation of the door locking knob 200.

The inner handle 120 is generally in the form of a “[” mark, and both ends 122 of the inner handle 120 are inserted into the insertion holes 112 of the housing 110, projected to the rear surface of the housing 110 and fixed to rotate on hinge shafts (A and B), such that a grip part 121 of the center of the inner handle 120 is arranged in the inner handle seating space 111 of the housing 110. The inner handle 120 has a rod connecting part 122a formed at the lower end 122 of the inner handle 120 to connect a rod 611.

The inner handle operation controlling means 130 includes: a rotational member 133 rotated with the ends 122 of the inner handle 120, the rotational member 133 having a groove 133b formed at the external surface, through which an end of a spring is projected, and a hole 133a formed at the bottom of the inner handle operation controlling means 130 to insert and engage the upper end 122 of the inner handle 120; a spring fixing member 131 fit to an upper open portion of the rotational member 133 and engaged and fixed to the fixing part 113a of the housing 110, the spring fixing member 131 having a fixed part 131a of a convexo-concave form, which is formed at the upper surface and engages the fixing part 113a of the housing 110, and a groove 131b formed at the external surface of the spring fixing member 131, through which the other end of the spring is projected; and a torsion spring 132 seated in the spring fixing member 131, the torsion spring having both ends projected through the groove 133b of the rotational member 133 and the groove 131b of the spring fixing member 131 respectively and resiliently supported at both sides of the grooves 131b and 133b. The inner handle operation controlling means 130 is inserted between the upper end 122 of the inner handle 120 and the hinge connecting part 113 having the fixing part 113a and fixed through the medium of the hinge shaft (A).

In FIGS. 2a and 2b, the operation part 210 of the door locking knob 200 is pressed in the left direction, the door locking knob 200 is off, and the inner handle 120 is located in the neutral position by the restoring force of the torsion spring 132. Under this condition, supposing that the sliding door 10 is closed, the operation of the sliding door opening and shutting device will be described. In the state that the sliding door 10 is closed, if the passenger pulls or pushes the inner handle 120 in the door opening direction, the inner handle 120 is rotated in the door opening direction on the hinge shafts (A and B), and thereby the rod 611 connected to the rod connecting part 122a of the inner handle 120 is pulled. After that, the locking controller 300 connected to the rod 611 is operated corresponding to the operation of the rod 611 to release the door-close maintaining means 400 from the gripped state, and thereby the sliding door 10 is opened. After that, when the sliding door 10 is continuously opened and reaches a prescribed position, the door-open maintaining means 500 engages the structure of a car, and thereby the sliding door 10 maintains the opened state by the door-open maintaining means 500.

In this condition, if the passenger pulls or pushes the inner handle 120 in the door closing direction, the inner handle 120 is rotated in the door closing direction on the hinge shafts (A and B), and thereby the rod 611 connected to the rod connecting part 122a of the inner handle 120 is pulled. After that, the locking controller 300 connected to the rod 611 is operated corresponding to the operation of the rod 611 to release the door-open maintaining means 500 from the gripped state, and thereby the sliding door 10 is closed.

After that, when the sliding door 10 is continuously closed and reaches a prescribed position, the door-close maintaining means 400 engages the structure of a car, and thereby the sliding door 10 maintains the closed state by the door-close maintaining means 400.

Meanwhile, if the inner handle 120 is turned in any one direction, in the state that one end of the torsion spring 132 is fixed on one side of the groove 131b of the spring fixing member 131, the other end of the torsion spring 132 is pressed by the other end of the groove 133b of the rotational member 133, which is rotated. At this time, if the passenger put the inner handle 120 off, the inner handle 120 is returned to the neutral position by the restoring force of the torsion spring 132.

In the state of FIGS. 2a and 2b, if the passenger presses the operation part 210 of the door locking knob 200 to the left direction and turns on the door locking knob 200, the door locking knob 200 is rotated in the door opening direction, and thereby the rod 641 connected to the rod connecting part 220 is pulled. After that, the locking controller 300 connected to the rod 641 is operated corresponding to the operation of the rod 641, and thereby the sliding door 10 is not opened even though the inner handle 120 is turned in the door opening direction.

According to the present invention, if the inner handle 120 is pushed or pulled in the door opening direction in the state that the sliding door 10 is closed, the inner handle 120 is turned in the door opening direction from the neutral position, and thereby the door-close maintaining means 400 is released by the locking controller 300. If the inner handle 120 is pulled or pushed in the door closing direction in the state that the sliding door 10 is opened, the inner handle 120 is turned in the door closing direction from the neutral position, and thereby the door-open maintaining means 500 is released by the locking controller 300. Therefore, the opening and shutting of the sliding door 10 can be performed sufficiently only by turning the inner handle 120 in one direction, i.e., in the door opening direction or in the door closing direction.

As previously described, according to the present invention, the inner handle is fixed at the housing to rotate in both directions and always returned to the neutral position by the inner handle operation controlling means. Therefore, if the inner handle is turned in the door opening direction or in the door closing direction from the neutral position, the door-open maintaining means or the door-close maintaining means is released. Therefore, only by applying power in any one direction of the inner handle, the sliding door can be easily opened or shut, thereby providing the passenger with the convenience.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An inner handle assembly of a sliding door comprising:
a housing having a plurality of coupling parts and/or projections, the housing being assembled inside the sliding door through the medium of a coupling member such as a screw;
an inner handle hinged to the housing to rotate in both directions; and
an inner handle operation controlling means for controlling the operation of the inner handle to be always returned to a neutral position.

2. The inner handle assembly as claimed in claim 1, wherein the housing includes a knob insertion hole formed at a portion located higher than the inner handle seating space to insert a door locking knob through the knob insertion hole such that the door locking knob is rotatably mounted on a hinge shaft, the hinge shaft being located at the center of the door locking knob to make the door locking knob rotate in right and left directions on the hinge shaft, and wherein the door locking knob includes an operation part formed on an exposed surface of the door locking knob, a rod connecting part formed at the rear surface to connect a rod, and a stopper for controlling an angle of rotation of the door locking knob.

3. The inner handle assembly as claimed in claim 1, wherein the inner handle operation controlling means includes:
a rotational member rotated with upper and lower ends of the inner handle, the rotational member having a groove formed at the external surface, through which an end of a spring is projected, and a hole formed at the bottom of the inner handle operation controlling means to insert and engage the upper end of the inner handle;
a spring fixing member fit to an upper open portion of the rotational member and engaged and fixed to the fixing part of the housing, the spring fixing member having a fixed part of a convexo-concave form, which is formed at the upper surface and engages the fixing part of the housing, and a groove formed at the external surface of the spring fixing member, through which the other end of the spring is projected; and
a torsion spring seated in the spring fixing member, the torsion spring having both ends projected through the groove of the rotational member and the groove of the spring fixing member respectively and resiliently supported at both sides of the grooves,
wherein the inner handle operation controlling means is inserted between the upper end of the inner handle and the hinge connecting part having the fixing part and fixed through the medium of the hinge shaft.
